(19) United States
(12) Patent Application Publication
(10) Pub. No.: US 2022/0389254 A1
(43) Pub. Date: Dec. 8, 2022

(54) LIQUID DISCHARGE APPARATUS AND METHOD FOR WIPING LIQUID DISCHARGE UNIT

(71) Applicants: Ayaka TANAKA, Kanagawa (JP); Takumi ATAKE, Tokyo (JP); Yohta SAKON, Kanagawa (JP)

(72) Inventors: Ayaka TANAKA, Kanagawa (JP); Takumi ATAKE, Tokyo (JP); Yohta SAKON, Kanagawa (JP)

(21) Appl. No.: 17/751,680

(22) Filed: May 24, 2022

(30) Foreign Application Priority Data
May 26, 2021 (JP) 2021-088650

(51) Int. Cl. C09D 11/36; B41J 2/165; C09D 11/322

(52) U.S. Cl. CPC C09D 11/36; B41J 2/16535; C09D 11/322

(57) ABSTRACT

A liquid discharge apparatus includes: an ink composition containing 2-pyrrolidone and an alcohol having a main chain having 6 or less carbon atoms; a liquid discharge unit configured to discharge the ink composition from a nozzle formed in a nozzle surface; and a wiping unit configured to wipe the nozzle surface. The wiping unit includes a wiping member including protrusion-shape fibers. Each of the protrusion-shape fibers has a protruded portion in a cross-section orthogonal to a fiber axis thereof. The protruded portion is continuous in a direction along the fiber axis.

### CROSS-REFERENCE TO RELATED APPLICATIONS

This patent application is based on and claims priority pursuant to 35 U.S.C. § 119(a) to Japanese Patent Application No. 2021-088650 filed on May 26, 2021, in the Japan Patent Office, the entire disclosure of which is hereby incorporated by reference herein.

### BACKGROUND

### Technical Field

The present disclosure relates to a liquid discharge apparatus and a method for wiping a liquid discharge unit.

### Description of the Related Art

Inkjet printers have such advantages as low noise, low running cost, and easiness in color printing, and they have been widely used as output devices of digital signals. In recent years, low- or non-absorbing print media such as coat paper sheets and plastic films have been used as print targets of inkjet printing, and inks for these print media have been developed. However, when inkjet printing is performed on those low- or non-absorbing print media, the ink does not permeate into the print media, and the ink is not dried as a result. This leads to poor fixability of the ink. To address such a disadvantageous phenomenon, a technique of increasing the amount of a resin in the ink is known. Meanwhile, liquid discharge apparatuses typified by inkjet printers cause failures such as discharge failures due to foreign matter on nozzle surfaces thereof. It is desirable to clean the nozzle surfaces on a regular basis. A known method therefor is cleaning the nozzle surfaces with a wiping member typified by a non-woven or woven sheet.

### SUMMARY

According to one aspect of the present disclosure, a liquid discharge apparatus includes: an ink composition containing 2-pyrrolidone and an alcohol having a main chain having 6 or less carbon atoms; a liquid discharge unit configured to discharge the ink composition from a nozzle formed in a nozzle surface; and a wiping unit configured to wipe the nozzle surface. The wiping unit includes a wiping member including protrusion-shape fibers. Each of the protrusion-shape fibers has a protruded portion in a cross-section orthogonal to a fiber axis thereof. The protruded portion is continuous in a direction along the fiber axis.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram for describing a definition of a protruded portion in a cross-section of a protrusion-shape fiber orthogonal to a fiber axis thereof:

FIG. 2 is a diagram schematically illustrating examples of cross-sections of protrusion-shape fibers orthogonal to fiber axes of the protrusion-shape fibers;

FIGS. 3A to 3C are diagrams schematically illustrating examples of relationships between cross-sections of protrusion-shape fibers orthogonal to fiber axes thereof and circumscribed circles of the cross-sections;

FIG. 4 is a diagram schematically illustrating an image forming apparatus as one example of a liquid discharge apparatus of the present disclosure;

FIG. 5 is a diagram schematically illustrating one example of a nozzle surface of a liquid discharge unit in a liquid discharge apparatus of the present disclosure; and

FIG. 6 is a diagram schematically illustrating one example of a wiping system including a wiping unit in a liquid discharge apparatus of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The present disclosure provides a liquid discharge apparatus excellent in drying property of an image, discharge stability brought by prevention of drying of an ink in the vicinity of a nozzle, and wiping performance for an adhesion ink.

### (Liquid Discharge Apparatus)

A liquid discharge apparatus of the present disclosure includes a liquid discharge unit and a wiping unit and preferably further includes a pressing unit. If necessary, the liquid discharge apparatus further includes other units.

The liquid discharge apparatus of the present disclosure includes: the liquid discharge unit, which is configured to discharge an ink composition from a nozzle formed in a nozzle surface; and the wiping unit, which is configured to wipe the nozzle surface. The ink composition, included in the liquid discharge apparatus, contains at least 2-pyrrolidone and an alcohol having a main chain having 6 or less carbon atoms. The wiping unit includes a wiping member including protrusion-shape fibers. Each of the protrusion-shape fibers has a protruded portion in a cross-section orthogonal to a fiber axis thereof. The protruded portion is continuous in a direction along the fiber axis.

### (Method for Wiping Liquid Discharge Unit)

A method of the present disclosure for wiping a liquid discharge unit includes a wiping step and preferably further includes a pressing step. If necessary, the method further includes other steps.

The method of the present disclosure for wiping a liquid discharge unit includes the wiping step, which is a step of wiping, with a wiping unit, a nozzle surface in a liquid discharge unit configured to discharge an ink composition from a nozzle formed in a nozzle surface. The ink composition contains at least 2-pyrrolidone and an alcohol having a main chain having 6 or less carbon atoms. The wiping unit includes a wiping member including protrusion-shape fibers. Each of the protrusion-shape fibers has a protruded portion in a cross-section orthogonal to a fiber axis thereof. The protruded portion is continuous in a direction along the fiber axis.

The method for wiping the liquid discharge unit can be suitably performed by the liquid discharge apparatus. The wiping step can be suitably performed by the wiping unit in the liquid discharge apparatus. The pressing step can be suitably performed by the pressing unit.

Cleaning with existing wiping members is poor in wiping performance for an adhesion ink, which is formed after drying of an ink on a nozzle surface. Increased number or pressure of wiping disadvantageously leads to degradation of a water-repellant film of the nozzle surface. In particular, an ink having higher drying property more easily forms the adhesion ink on the nozzle surface. This leads to degradation in image quality and to an increase in the number of cleaning operations to result in poor productivity.

The liquid discharge apparatus of the present disclosure and the method of the present disclosure for wiping the liquid discharge unit are excellent in drying property of an image, discharge stability brought by prevention of drying of an ink in the vicinity of a nozzle, and wiping performance for an adhesion ink.

Hereinafter, the liquid discharge apparatus of the present disclosure will be described together with the method of the present disclosure for wiping the liquid discharge unit.

### <Liquid Discharge Unit>

The liquid discharge unit included in the liquid discharge apparatus is a unit configured to discharge an ink composition from a nozzle formed in a nozzle surface. The liquid discharge unit is suitably a liquid discharge head, for example.

The nozzle surface of the liquid discharge unit preferably includes a water-repellant film on a surface thereof.

The water-repellant film represents a film having water repellency. An example of the water-repellant film is a film having a pure water contact angle of 60 degrees or higher. The contact angle is an angle that is measured by the θ/2 method.

When the water-repellant film is formed on the nozzle surface, formation of scratches in the nozzle surface more significantly reduces discharge stability. Use of the wiping unit makes it possible to perform wiping while reducing the linear pressure at a contact portion between the wiping member in the wiping unit and the nozzle surface. This can prevent the formation of scratches in the nozzle surface, resulting in prevention of the reduction in discharge stability.

### <Wiping Unit and Wiping Step>

The wiping unit is a unit configured to wipe the nozzle surface in the liquid discharge unit. The wiping unit includes a wiping member and if necessary, further includes other members.

The wiping step is a step of wiping, with a wiping unit, the nozzle surface in the liquid discharge unit configured to discharge an ink composition from a nozzle formed in a nozzle surface. The wiping step can be suitably performed by the wiping unit.

In the present specification, the term “wiping” refers to moving the wiping unit and the liquid discharge unit relatively to each other while contacting the wiping unit and the nozzle surface with each other. Wiping the nozzle surface with the wiping unit makes it possible to remove from the nozzle surface, for example, adhesion matter deposited on the nozzle surface after drying of the ink composition. Also, wiping the nozzle surface with the wiping unit makes it possible to remove the excessive ink composition from the nozzle surface by, for example, absorbing the excessive ink composition from the nozzle.

The wiping unit preferably wipes the nozzle surface by contacting the wiping member with the nozzle surface of the liquid discharge unit.

### <<Wiping Member>>

The wiping member includes protrusion-shape fibers and if necessary, further includes fibers of other shapes. The wiping member can contain a cleaning liquid upon wiping.

When the wiping member includes the protrusion-shape fibers, wiping performance can be improved in removing from the nozzle surface the adhesion matter deposited on the nozzle surface after drying of the ink composition. Even when reducing the linear pressure at a contact portion between the wiping member and the nozzle surface, the adhesion matter can be effectively removed. Because wiping can be performed while reducing the linear pressure at a contact portion between the wiping member and the nozzle surface, formation of scratches in the nozzle surface is prevented, resulting in prevention of the reduction in discharge stability.

The form of the wiping member is not particularly limited as long as the wiping member includes the protrusion-shape fibers, and may be appropriately selected depending on the intended purpose. The form of the wiping member is preferably a sheet. The wiping member may have a single layered structure of only one layer where the wiping member includes at least the protrusion-shape fibers at a contact side (a contact surface) with the nozzle surface of the liquid discharge unit, which is a member to be wiped. Alternatively, the wiping member may have a laminated structure including: a layer including the protrusion-shape fibers at a contact side with the nozzle surface; and at least one layer other than the above layer.

Examples of the laminated structure include, but are not limited to: the above laminated structure further including a layer having functions of, for example, retaining the absorbed ink; a three-layered structure lined with a film for preventing offset of the absorbed ink and increasing the strength of the wiping member; a multi-layered structure including several absorbing layers different in absorbency provided after the second layer; and a multi-layered structure provided with a porous body such as a sponge. Examples of the porous body include, but are not limited to, polyurethane, polyolefin, and polyvinyl alcohol (PVA).

The wiping member is preferably cloth such as non-woven fabric, woven fabric, or knitted fabric, in terms of the ability to absorb liquid such as an ink. These may be used alone or in combination. Of these, non-woven fabric is preferable because the non-woven fabric is relatively easy in terms of controlling the thickness and the porosity thereof and in terms of formulating various kinds of fibers.

The material of the fibers constituting the wiping member is not particularly limited and may be appropriately selected depending on the intended purpose. Examples thereof include, but are not limited to, cotton, hemp, silk, pulp, nylon, vinylon, polyester, polypropylene, polyethylene, rayon, cupra, acrylic, and polylactic acid. These may be used alone or in combination.

It is preferable to select, as the material of the fibers constituting the wiping member, a material with which the adhesion matter deposited on the nozzle surface after drying of the ink composition is easily wiped. Inclusion of a material having high water absorbency such as rayon can provide the wiping member with a function of absorbing the excessive ink composition.

As one example of the method for producing the wiping member, the case where the wiping member is non-woven fabric will be described.

The method for forming the non-woven fabric is not particularly limited and may be appropriately selected from known methods depending on the intended purpose. Examples thereof include, but are not limited to, wet type, dry type, spun bonding, melt blown, and flash spinning.

The method for bonding the non-woven fabric is not particularly limited and may be appropriately selected depending on the intended purpose. Examples thereof include, but are not limited to, spun lacing, needle punching, thermal bonding, and chemical bonding.

The spun lacing is a production process where a jet water stream is jetted onto stacked fibers and the fibers are intertwined and bonded into a sheet by the pressure resulting from jetting.

The needle punching is a production process where stacked fibers are stuck at several tens of times or more with a needle with protrusions, which is called a barb, to physically entwine the fibers together into non-woven fabric.

The porosity of the wiping member is not particularly limited and may be appropriately selected depending on the intended purpose. The porosity calculated from Formula (1) below is preferably 0.60 or more but 0.99 or less. When the porosity of the wiping member is within the above preferable range, it is possible to improve wiping performance for the adhesion matter deposited on the nozzle surface after drying of the ink composition, and also it is possible for the wiping member to retain a sufficient amount of a cleaning liquid described below, which is advantageous.

Porosity=1−Apparent density/True density Formula (1)

When the wiping member is in the form of a sheet, the “True density” in Formula (1) is the true density of the fibers forming the sheet, and the “Apparent density” in Formula (1) can be obtained by dividing the basis weight of the material in the form of a sheet by thickness; i.e., “basis weight/thickness”.

The thickness of the wiping member is not particularly limited and may be appropriately selected depending on the intended purpose. The thickness thereof is preferably 0.1 mm or more but 3.0 mm or less. When the thickness of the wiping member is within the above preferable range, it is possible to improve wiping performance for the adhesion matter deposited on the nozzle surface after drying of the ink composition, and also it is possible for the wiping member to retain a sufficient amount of a cleaning liquid described below, which is advantageous.

### —Protrusion-Shape Fibers—

Each of the protrusion-shape fibers has a protruded portion in a cross-section orthogonal to a fiber axis thereof. The protruded portion is continuous in a direction along the fiber axis. In other words, each of the protrusion-shape fibers has such a shape that protruded portions and recessed portions are alternatingly provided in a cross-section orthogonal to a fiber axis thereof. The protrusion-shape fibers may have hollow portions.

The number of the protruded portions in the cross-section of the protrusion-shape fiber orthogonal to the fiber axis thereof is not particularly limited and may be appropriately selected depending on the intended purpose. Preferably, two or more protruded portions are preferably present in the cross-section. The lower limit of the number thereof is preferably 3 or more, more preferably 4 or more, further preferably 5 or more, and particularly preferably 6 or more. The upper limit of the number of the protruded portions in the cross-section of the protrusion-shape fiber orthogonal to the fiber axis thereof is not particularly limited and may be appropriately selected depending on the intended purpose. The upper limit of the number thereof is preferably 12 or less, more preferably 11 or less, and further preferably 10 or less. Wiping performance is improved when the number of the protruded portions in the cross-section of the protrusion-shape fiber orthogonal to the fiber axis thereof is 3 or more or 12 or less.

In the present specification, the term “protruded portion” refers to a portion that forms a region protruded from a circle having the minimum diameter among circles each having contact points with recessed portions in the cross-section of the protrusion-shape fiber orthogonal to the fiber axis thereof.

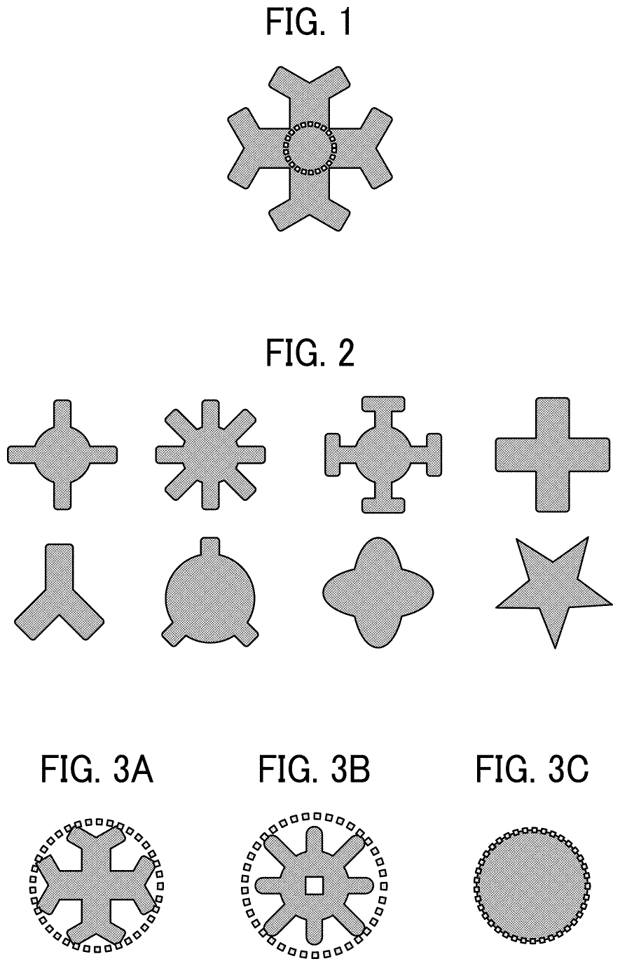

FIG. 1 is a diagram for describing the definition of the protruded portion in the cross-section of the protrusion-shape fiber orthogonal to the fiber axis thereof. The cross-section orthogonal to the fiber axis of the protrusion-shape fiber is indicated in black. The circle having the minimum diameter among circles each having contact points with recessed portions in the cross-section is indicated by a white dotted line. With the circle denoted by the gray dotted line being a reference circle, regions protruded from the reference circle are protruded portions (four regions in FIG. 1).

When the tip of the protruded portion has branched shapes, the number of the branched portions are not included in the number of the protruded portions in the cross-section of the protrusion-shape fiber orthogonal to the fiber axis thereof.

The protruded portion in the cross-section of the protrusion-shape fiber orthogonal to the fiber axis thereof is formed continuously in a direction along the fiber axis. When the protruded portion is continuous in the direction along the fiber axis, wiping performance is improved because the protruded portion can more broadly contact the adhesion matter deposited on the nozzle surface after drying of the ink composition.

The protruded portion in the cross-section of the protrusion-shape fiber orthogonal to the fiber axis thereof is continuous in the direction along the fiber axis as described above. The protruded portion may be continuous over the full length (the fiber length) in the direction along the fiber axis of the protrusion-shape fiber. The protruded portion may be continuous over a portion corresponding to the length of part of the full length in the direction along the fiber axis of the protrusion-shape fiber.

The portion corresponding to the length of the part of the full length in the direction along the fiber axis of the protrusion-shape fiber is not particularly limited and may be appropriately selected depending on the intended purpose. It is preferably a portion corresponding to the length of 10% or more of the full length in the direction along the fiber axis of the protrusion-shape fiber, more preferably a portion corresponding to the length of 20% or more thereof, still more preferably a portion corresponding to the length of 30% or more thereof, even more preferably a portion corresponding to the length of 40% or more thereof, and particularly preferably a portion corresponding to the length of 50% or more thereof.

The diameter of one single fiber of the protrusion-shape fibers is not particularly limited and may be appropriately selected depending on the intended purpose. The diameter thereof is preferably 10 micrometers or more but 50 micrometers or less and 20 micrometers or more but 30 micrometers or less.

The fiber length of the protrusion-shape fiber is not particularly limited and may be appropriately selected depending on the intended purpose. The fiber length thereof is preferably 1 mm or more but 100 mm or less, more preferably 20 mm or more but 80 mm or less, and further preferably 40 mm or more but 60 mm or less.

The other fibers than the protrusion-shape fiber (e.g., fibers each having a cross-section of the fiber approximating a true circle or an ellipse where the cross-section is orthogonal to a fiber axis of the fiber) are expected to have protruded and recessed portions in the surfaces thereof and to partially have protruded portions. However, the protruded portions of such fibers are not formed continuously in the direction along the fiber axes thereof, and thus they are clearly distinguished from the protrusion-shape fibers.

The protruded portions in the cross-sections orthogonal to the fiber axes of the protrusion-shape fibers will be described in detail with reference to FIG. 2. However, the protrusion-shape fibers are not limited thereto.

FIG. 2 is a diagram schematically illustrating examples of the protruded portions in the cross-sections of the protrusion-shape fibers orthogonal to the fiber axes thereof. As illustrated in FIG. 2, the protruded portions in the cross-sections of the protrusion-shape fibers orthogonal to the fiber axes thereof are not particularly limited and may be appropriately selected depending on the intended purpose. The protrusion-shape fibers may have, for example, a cross-shaped cross-section, an H-shaped cross-section, a T-shaped cross-section, a Y-shaped cross-section, and a multi-fin cross-section. The protrusion-shape fiber may be: a protrusion-shape fiber having a hollow portion in the protruded portion in the cross-section of the protrusion-shape fiber orthogonal to the fiber axis thereof; a protrusion-shape fiber having a shape where the tip of the protruded portion in the cross-section of the protrusion-shape fiber orthogonal to the fiber axis thereof is branched; and a protrusion-shape fiber having a flat circumscribed circle of the cross-section of the protrusion-shape fiber orthogonal to the fiber axis thereof where the cross-section is a flat, multi-leaf cross-section having a multi-leaf shape (e.g., the fiber shapes described in JP-2005-350777-A, JP-04-024214-A, and JP-2012-162826-A).

A method for confirming the protruded portion in the cross-section of the protrusion-shape fiber orthogonal to the fiber axis thereof is not particularly limited and may be appropriately selected depending on the intended purpose. Examples of the method include, but are not limited to, a method where the protrusion-shape fibers are embedded with an embedding agent such as an epoxy resin, and the embedded product of the fibers is cut to form a cross-section thereof, followed by observation under a scanning electron microscope (SEM).

In the cross-section of the protrusion-shape fiber orthogonal to the fiber axis thereof, the number of regions formed by part of the periphery of the cross-section and part of the circumscribed circle of the cross-section is not particularly limited and may be appropriately selected depending on the intended purpose. The number of regions formed therebetween is preferably two or more. The lower limit thereof is preferably 3 or more and more preferably 4 or more. In the cross-section of the protrusion-shape fiber orthogonal to the fiber axis thereof, the upper limit of the number of regions formed by part of the periphery of the cross-section and part of the circumscribed circle of the cross-section is not particularly limited and may be appropriately selected depending on the intended purpose. The upper limit thereof is preferably 9 or less and more preferably 8 or less. In the cross-section of the protrusion-shape fiber orthogonal to the fiber axis thereof, when the number of regions formed by part of the periphery of the cross-section and part of the circumscribed circle of the cross-section is 3 or more or 9 or less, wiping performance is improved.

In the present specification, the term “circumscribed circle of the cross-section” refers to a circle having the minimum diameter among circles each having contact points with the periphery in the cross-section of the protrusion-shape fiber orthogonal to the fiber axis thereof.

The fiber porosity of the protrusion-shape fiber is not particularly limited and may be appropriately selected depending on the intended purpose. The fiber porosity of the protrusion-shape fiber calculated from Formula (2) below is preferably 20% or more but 80% or less, more preferably 30% or more but 70% or less, further preferably 45% or more but 65% or less, and particularly preferably 50% or more but 60% or less. When the fiber porosity of the protrusion-shape fiber is within the above preferable range, wiping performance is improved.

Fiber porosity=(1−A/B)×100 Formula (2)

In the Formula (2), “A” denotes an area of the cross-section of the protrusion-shape fiber orthogonal to the fiber axis thereof, and “B” denotes an area of the circumscribed circle of the cross-section of the protrusion-shape fiber orthogonal to the fiber axis thereof. When the protrusion-shape fiber has a hollow portion, the area of the hollow portion is not included in the above cross-sectional area “A”.

FIG. 3A to 3C are diagrams schematically illustrating examples of relationships between the cross-sections of the protrusion-shape fibers orthogonal to the fiber axes thereof and the circumscribed circles of the cross-sections. The cross-sections of the protrusion-shape fibers orthogonal to the fiber axes thereof are indicated in gray. The circumscribed circles of the cross-sections are indicated by gray dotted lines. FIGS. 3A and 3B illustrate the protrusion-shape fibers, and FIG. 3C illustrates a fiber without any protruded portion. In FIGS. 3A to 3C, in the cross-section of the protrusion-shape fiber orthogonal to the fiber axis thereof, the number of regions formed by part of the periphery of the cross-section and part of the circumscribed circle of the cross-section is 8 in FIG. 3A, 4 in FIG. 3B, and 0 in FIG. 3C. The fiber porosity of the protrusion-shape fiber is 42% in FIG. 3A, 55% in FIG. 3B, and 0% in FIG. 3C.

A method for producing the protrusion-shape fibers is not particularly limited and may be appropriately selected from known methods depending on the intended purpose. Examples of the method include, but are not limited to: a production method by appropriately designing the shape of a spinneret; and a production method by dividing a fiber after spinning utilizing, for example, phase separation.

The proportion of the protrusion-shape fibers in the wiping member is not particularly limited and may be appropriately selected depending on the intended purpose. The proportion of the protrusion-shape fibers to the total mass of the wiping member is preferably 20% by mass or more and more preferably 40% by mass or more relative to the total mass of the wiping member. All of the fibers constituting the wiping member may be the protrusion-shape fibers.

The protrusion-shape fibers for use may be appropriately synthesized fibers or commercially available fibers.

Examples of the commercially available products of the protrusion-shape fibers or commercially available sheets formed using the protrusion-shape fibers include, but are not limited to: as product names, OCTA (registered trademark) (obtained from TEIJIN FRONTIER CO., LTD.), DILLA (registered trademark) D0903WPO (obtained from UNITIKA LTD.), SOIERION (registered trademark) Y (obtained from KB SEIREN, LTD.), ARTIROSA (registered trademark) (obtained from Toray Industries, Inc.), PENTAS (registered trademark) a (obtained from Toray Industries, Inc.), CERESDRY (registered trademark) (obtained from TOYOBO CO., LTD.), and PYUAS (obtained from KURARAY TRADING CO., LTD.).

The linear pressure at a contact portion between the wiping member and the nozzle surface when the wiping member wipes the nozzle surface is not particularly limited and may be appropriately selected depending on the intended purpose. The upper limit thereof is preferably 1.7 N/cm or less, more preferably 1.5 N/cm or less, still more preferably 1.0 N/cm or less, even more preferably 0.8 N/cm or less, and particularly preferably 0.6 N/cm or less. When the linear pressure at the contact portion between the wiping member and the nozzle surface is 1.7 N/cm or less, it is possible to prevent reduction in discharging ability due to scratches, which would otherwise be formed in the nozzle surface when the wiping member removes from the nozzle surface the adhesion matter deposited thereon after drying of the ink composition. In general, when the linear pressure at the contact portion between the wiping member and the nozzle surface is 1.7 N/cm or less, wiping performance may be reduced. When the wiping member in the wiping unit includes the protrusion-shape fibers, the reduction in wiping performance is prevented. This makes it possible to adjust the linear pressure at the contact portion between the wiping member and the nozzle surface to 1.7 N/cm or less, resulting in prevention of the reduction in discharging ability and the reduction in wiping performance.

The lower limit of the linear pressure at the contact portion between the wiping member and the nozzle surface when the wiping member wipes the nozzle surface is not particularly limited and may be appropriately selected depending on the intended purpose. The lower limit thereof is preferably 0.1 N/cm or more, more preferably 0.2 N/cm or more, and further preferably 0.3 N/cm or more. When the linear pressure at the contact portion between the wiping member and the nozzle surface is 0.1 N/cm or more, wiping performance is improved.

The linear pressure at the contact portion between the wiping member and the nozzle surface can be appropriately adjusted by, for example, adjusting the distance between the wiping member and the nozzle surface using a spring as the below-described pressing unit (e.g., a pressing roller 400 illustrated in FIG. 6).

The linear pressure at the contact portion between the wiping member and the nozzle surface is, as described above, measured when the wiping member wipes the nozzle surface. Alternatively, it may be measured indirectly from a device that reproduces the positional relationship between the wiping member and the nozzle surface when the wiping member wipes the nozzle surface. The linear pressure at the contact portion between the wiping member and the nozzle surface preferably refers to the highest linear pressure of linear pressures generated at the contact portion between the wiping member and the nozzle surface. In other words, the linear pressure is preferably 1.7 N/cm or less at all positions of the contact portion between the wiping member and the nozzle surface. Nonetheless, the linear pressure is not necessarily measured at all positions of the contact portion between the wiping member and the nozzle surface. For example, when the linear pressure is measured at any two or more positions of the contact portion between the wiping member and the nozzle surface and is 1.7 N/cm or less at any of the positions, it can be determined based on the obtained measurement results that the linear pressure is 1.7 N/cm or less at all positions of the contact portion between the wiping member and the nozzle surface.

A method for measuring the linear pressure at any two or more positions of the contact portion between the wiping member and the nozzle surface is not particularly limited and may be appropriately selected depending on the intended purpose. Examples of the method include, but are not limited to, a method of directly measuring the linear pressure from an actual device mounted with the wiping unit including the wiping member by using, for example, I-SCAN (obtained from NITTA Corporation) which is a surface pressure distribution measurement system, or PRESCALE (obtained from FUJIFILM Corporation) which is a pressure measurement film. Another example of the method is a method using the unit only to measure the load at the pressure therebetween comparable to that in the actual device and the contact length of the wiping member, to calculate the linear pressure.

### <Pressing Unit and Pressing Step>

The liquid discharge apparatus preferably further includes a pressing unit. The pressing unit is a unit configured to press the wiping member against the nozzle surface of the liquid discharge unit.

The pressing step is a step of pressing the wiping member against the nozzle surface of the liquid discharge unit. The pressing step can be suitably performed by the pressing unit.

### <Other Units and Other Steps>

The other units are not particularly limited as long as they do not impair the effects of the present disclosure. Examples of the other units include, but are not limited to, an ink composition accommodating unit, an ink composition supplying unit, a control unit, a cleaning liquid applying unit, a drying unit, a pre-processing unit, and a post-processing unit. As these units, known units can be appropriately used.

The other steps are not particularly limited as long as they do not impair the effects of the present disclosure. Examples of the other steps include, but are not limited to, an ink composition accommodating step, an ink composition supplying step, a control step, a cleaning liquid applying step, a drying step, a pre-processing step, and a post-processing step. These steps can be suitably performed by the other units.

### <<Control Unit and Control Step>>

The control unit is a unit configured to control the relative movement between the liquid discharge unit and the wiping member that is pressed against the nozzle surface by the pressing unit.

The control step is a step of controlling the relative movement between the liquid discharge unit and the wiping member that is pressed against the nozzle surface by the pressing unit. The control step can be suitably performed by the control unit.

### <<Cleaning Liquid Applying Unit and Cleaning Liquid Applying Step>>

The cleaning liquid applying unit is a unit configured to apply a cleaning liquid to the wiping member.

The cleaning liquid applying step is a step configured to apply a cleaning liquid to the wiping member. The cleaning liquid applying step can be suitably performed by the cleaning liquid applying unit. The cleaning liquid applying step is preferably performed before or after wiping in the wiping step.

The cleaning liquid applying unit is not particularly limited as long as a certain amount of the cleaning liquid can be applied to the wiping member, and may be appropriately selected depending on the intended purpose. Examples of the cleaning liquid applying unit include, but are not limited to, a nozzle, spraying, a dispenser, a roller, a spray, and other known applicators.

### —Cleaning Liquid—

The cleaning liquid is not particularly limited and may be appropriately selected depending on the intended purpose. For example, the cleaning liquid preferably contains an organic solvent, a surfactant, water, and other components. When the nozzle surface is wiped with the wiping unit after the cleaning liquid has been directly or indirectly applied to the nozzle surface, the adhesion matter deposited on the nozzle surface after drying of the ink composition decreases in viscosity, leading to easy removal. Preferably, the cleaning liquid is charged to a cleaning liquid accommodating container which is mounted to the wiping unit, and the cleaning liquid is applied from the cleaning liquid applying unit.

### —Organic Solvent—

The organic solvent in the cleaning liquid is not particularly limited and may be appropriately selected depending on the intended purpose. Examples thereof include, but are not limited to, water-soluble organic solvents.

The water-soluble organic solvents are not particularly limited and may be appropriately selected depending on the intended purpose. Examples of the water-soluble organic solvents include, but are not limited to, polyvalent alcohols, nitrogen-containing heterocyclic compounds, amides, amines, sulfur-containing compounds, propylene carbonate, ethylene carbonate, polyol compounds having 8 or more carbon atoms, and glycol ether compounds. These water-soluble organic solvents may be used alone or in combination.

### —Polyvalent Alcohols—

Specific examples of the polyvalent alcohols include, but are not limited to, ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropyleneglycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol.

### —Nitrogen-Containing Heterocyclic Compounds—

Specific examples of the nitrogen-containing heterocyclic compounds include, but are not limited to, 2-pyrolidone, N-methyl-2-pyrolidone, N-hydroxyethyl-2-pyrolidone, 1,3-dimethyl-2-imidazolidinone, ε-caprolactam, and γ-butyrolactone.

### —Amides—

Specific examples of the amides include, but are not limited to, formamide, N-methylformamide, N,N-dimethylformamide, 3-methoxy-N,N-dimethylpropionamide, and 3-butoxy-N,N-dimethylpropionamide.

### —Amines—

Specific examples of the amines include, but are not limited to, monoethanolamine, diethanolamine, and triethylamine.

### —Sulfur-Containing Compounds—

Specific examples of the sulfur-containing compounds include, but are not limited to, dimethylsulfoxide, sulfolane, and thiodiethanol.

### —Polyol Compounds Having 8 or More Carbon Atoms—

Specific examples of the polyol compounds having 8 or more carbon atoms include, but are not limited to, 2-ethyl-1,3-hexanediol and 2,2,4-trimethyl-1,3-pentanediol.

### —Glycol Ether Compounds—

Specific examples of the glycol ether compounds include, but are not limited to: polyvalent alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; and polyvalent alcohol aryl ethers such as ethylene glycol monophenyl ether and ethylene glycol monobenzyl ether.

The content of the organic solvent in the cleaning liquid is not particularly limited and may be appropriately selected depending on the intended purpose. It is preferably 10.0% by mass or more but 50.0% by mass or less and more preferably 20.0% by mass or more but 30.0% by mass or less, relative to the total content of the cleaning liquid.

### —Surfactant—

The surfactant in the cleaning liquid is not particularly limited and may be appropriately selected depending on the intended purpose. Examples of the surfactant include, but are not limited to, polyoxyalkylene surfactants, silicone-based surfactants, fluoro surfactants, amphoteric surfactants, nonionic surfactants, and anionic surfactants. These surfactants may be used alone or in combination. Of these surfactants, polyoxyalkylene surfactants and silicone-based surfactants are preferable. Polyoxyalkylene surfactants are particularly preferable in terms of wiping performance with cleaning liquid for the adhesion matter deposited on the nozzle surface after drying of the ink composition and of storage stability of the cleaning liquid.

### —Polyoxyalkylene Surfactants—

The polyoxyalkylene surfactants are not particularly limited and may be appropriately selected depending on the intended purpose. Examples of the polyoxyalkylene surfactants include, but are not limited to, polvoxyethylene distyrenated phenyl ether and polyoxyethylene polyoxypropylene alkyl ether.

The polyoxyalkylene surfactants for use may be appropriately synthesized polyoxyalkylene surfactants or commercially available polyoxyalkylene surfactants. Examples of the commercially available polyoxyalkylene surfactants include, but are not limited to, EMULGEN A-60 (polyoxyethylene distyrenated phenyl ether), EMULGEN LS-106 (polyoxyethylene polyoxypropylene alkyl ether), and EMULGEN LS-110 (polyoxyethylene polyoxypropylene alkyl ether) (all of which are higher alcohol ether nonionic surfactants, obtained from Kao Corporation). These poly oxyalkylene surfactants may be used alone or in combination.

### —Silicone-Based Surfactants—

The silicone-based surfactants are not particularly limited and may be appropriately selected depending on the intended purpose. Examples of the silicone-based surfactants include, but are not limited to, side-chain-modified polydimethylsiloxane, both-end-modified polydimethylsiloxane, one-end-modified polydimethylsiloxane, and side-chain-both-end-modified polydimethylsiloxane. These silicone-based surfactants may be used alone or in combination. Of these, a polyether-modified silicone surfactant including, as a modifying group, a polvoxyethylene group or polyoxyethylene polyoxypropylene group is particularly preferable because such a surfactant has excellent properties as an aqueous surfactant.

As the silicone surfactant, moreover, a polyether-modified silicone surfactant may be used. Examples of the polyether-modified silicone surfactant include, but are not limited to, a compound in which a polyalkylene oxide structure is introduced into a side chain of the Si site of dimethylsiloxane.

The silicone-based surfactants for use may be appropriately synthesized silicone-based surfactants or commercially available silicone-based surfactants. The commercially available silicone-based surfactants can be obtained from, for example, BYK Japan KK, Shin-Etsu Chemical Co., Ltd., Dow Corning Toray Co., Ltd., NIHON EMULSION Co., Ltd., and Kyoeisha Chemical Co., Ltd.

The polyether-modified silicone-based surfactant has no particular limit and can be suitably selected to suit to a particular application. Examples thereof include, but are not limited to, a compound in which the polyalkylene oxide structure represented by the following General formula (S-1) is introduced into the side chain of the Si site of dimethyl polysiloxane.

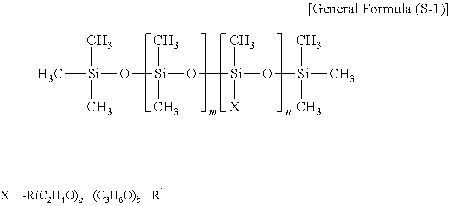

In General formula (S-1), “m”, “n”, “a”, and “b” each, respectively represent integers, R represents an alkylene group, and R′ represents an alkyl group.

Products available on the market or appropriately synthesized products may be used as the polyether-modified silicone-based surfactants. Specific examples of the products available on the market include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.). DOWSIL FZ-2105, DOWSIL FZ-2118, DOWSIL FZ-2154, DOWSIL FZ-2161, DOWSIL FZ-2162, FZ-2163, and DOWSIL FZ-2164 (all manufactured by Dow Corning Toray Silicone Co., Ltd.), BYK-33 and BYK-387 (both manufactured by Byk Chemie Japan Co., Ltd.), and TSF4440, TSF4452, and TSF4453 (all manufactured by Momentive Performance Materials Japan).

### —Fluoro Surfactants—

The fluoro surfactants are not particularly limited and may be appropriately selected depending on the intended purpose. For example, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain are particularly preferable because these fluoro surfactants do not foam easily. These may be used alone or in combination.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carboxylic acid compounds include, but are not limited to, perfluoroalkyl carboxylic acid and salts of perfluoroalkyl carboxylic acid.

Specific examples of the perfluoroalkyl phosphoric acid ester compounds include, but are not limited to, diethanol amine salts of perfluoroalkyl phosphoric acid ester.

Specific examples of the adducts of perfluoroalkyl ethylene oxide products include, but are not limited to: SURFLON (registered trademark) S-242, S-243, and S-420 (all manufactured by AGC SEIMI CHEMICAL CO., LTD.); MEGAFACE F-444 (manufactured by DIC CORPORATION); and ZONYL (registered trademark) FS-300, FSN, FSO-100, and FS-3100 (all manufactured by Du Pont).

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain.

Counter ions of salts in these fluoro surfactants are, for example, Li, Na, K, NH₄, NH₃CH₂CH₂OH, NH₂(CH₂CH₂OH)₂, NH(CH₂CH₂OH)₃.

### —Amphoteric Surfactants—

The amphoteric surfactants are not particularly limited and may be appropriately selected depending on the intended purpose. Specific examples of the amphoteric surfactants include, but are not limited to, lauryl aminopropionic acid salts, lauryl dimethyl betaine, stearyl dimethyl betaine, and lauryl dihydroxyethyl betaine. These may be used alone or in combination.

### —Nonionic Surfactants—

The nonionic surfactants are not particularly limited and may be appropriately selected depending on the intended purpose. Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides. These may be used alone or in combination.

### —Anionic Surfactants—

The anionic surfactants are not particularly limited and may be appropriately selected depending on the intended purpose. Specific examples of the anionic surfactants include, but are not limited to, polyoxyethylene alkyl ether acetates, dodecyl benzene sulfonates, laurates, and polyoxyethylene alkyl ether sulfates. These may be used alone or in combination.

The content of the surfactant in the cleaning liquid is not particularly limited and may be appropriately selected depending on the intended purpose. In terms of storage stability, it is preferably 0.001% by mass or more but 5% by mass or less, more preferably 0.05% by mass or more but 5% by mass or less, and further preferably 0.1% by mass or more but 3% by mass or less, relative to the total content of the cleaning liquid.

### —Water—

The water in the cleaning liquid is not particularly limited and may be appropriately selected depending on the intended purpose. Examples of the water include, but are not limited to, pure water, such as ion-exchanged water, ultrafiltration water, reverse osmosis-filtered water, distilled water, and ultrapure water. These may be used alone or in combination.

The content of the water in the cleaning liquid is not particularly limited and may be appropriately selected depending on the intended purpose. It is preferably 20.0% by mass or more but 80.0% by mass or less and 30.0% by mass or more but 60.0% by mass or less, relative to the total content of the cleaning liquid.

### —Other Components—

The other components in the cleaning liquid are not particularly limited and may be appropriately selected depending on the intended purpose. Examples of the other components include, but are not limited to, a defoaming agent, preservatives and fungicides, a corrosion inhibitor, and a pH regulator.

### —Defoaming Agent—

The defoaming agent in the cleaning liquid has no particular limit. Examples of the defoaming agent include, but are not limited to, silicone-based defoaming agents, polyether-based defoaming agents, and aliphatic acid ester-based defoaming agents. These may be used alone or in combination. Of these, silicone-based defoaming agents are preferable to easily break foams.

### —Preservatives and Fungicides—

The preservatives and fungicides in the cleaning liquid have no particular limit. Examples of the preservatives and fungicides include, but are not limited to, 1,2-benzisothiazoline-3-on.

### —Corrosion Inhibitor—

The corrosion inhibitor in the cleaning liquid has not particular limit. Examples of the corrosion inhibitor include, but are not limited to, acid sulfite and sodium thiosulfate. These may be used alone or in combination.

### —pH Regulator—

The pH regulator in the cleaning liquid has no particular limit as long as the pH can be adjusted to 7 or higher. Examples of the pH regulator include, but are not limited to, amines such as diethanol amine and triethanol amine. These may be used alone or in combination.

### <<Pre-Processing Unit and Pre-Processing Step>>

The pre-processing unit is a unit configured to discharge a pre-processing fluid to a print medium.

The pre-processing step is a step of discharging a pre-processing fluid to a print medium. The pre-processing step can be suitably performed by the pre-processing unit.

The pre-processing unit preferably includes: a pre-processing fluid accommodating portion configured to accommodate the pre-processing fluid; and a pre-processing fluid discharge head.

A method for discharging the pre-processing fluid is preferably an inkjet printing method. It may be a method other than the inkjet printing method, such as a blade coating method, a roll coating method, or a spray coating method.

### —Pre-Processing Fluid—

The pre-processing fluid is not particularly limited and may be appropriately selected depending on the intended purpose. The pre-processing fluid contains a flocculant, an organic solvent, water, and optional materials such as a surfactant, a defoaming agent, a pH regulator, a preservatives and fungicides, and a corrosion inhibitor.

The organic solvent, the surfactant, the defoaming agent, the pH regulator, the preservatives and fungicides, and the corrosion inhibitor can be the same material as those for use in the ink composition described below. Also, other materials for use in known pre-processing fluid can be used.

The type of the flocculant is not particularly limited and may be appropriately selected depending on the intended purpose. Examples of the flocculant include, but are not limited to, water-soluble cationic polymers, acids, and multi-valent metal salts.

### <<Post-Processing Unit and Post-Processing Step>>

The post-processing unit is a unit configured to discharge a post-processing fluid to a print medium.

The post-processing step is a step of discharging a post-processing fluid to a print medium. The post-processing step can be suitably performed by the post-processing unit.

The post-processing unit preferably includes: a post-processing fluid accommodating portion configured to accommodate the post-processing fluid; and a post-processing fluid discharge head.

A method for discharging the post-processing fluid is preferably an inkjet printing method. It may be a method other than the inkjet printing method, such as a blade coating method, a roll coating method, or a spray coating method.

### —Post-Processing Fluid—

The post-processing fluid has no particular limit. It is preferable that the post-processing fluid can form a transparent layer. Materials such as organic solvents, water, resins, surfactants, defoaming agents, pH regulators, preservatives and fungicides, corrosion inhibitors, etc. are suitably selected based on a necessity basis and mixed to obtain the post-processing fluid.

The organic solvent, the surfactant, the water, the resin, the surfactant, the defoaming agent, the pH regulator, the preservatives and fungicides, and the corrosion inhibitor can be the same material as those for use in the ink composition described below. Also, other materials for use in known post-processing fluid can be used.

The post-processing fluid can be applied to the entire printing area on a print medium or only the printed area where an ink image of the ink composition is formed.

### <Ink Composition>

Preferably, the ink composition is contained in an ink accommodating container which is one example of the liquid accommodating containers and the ink accommodating container is mounted to the liquid discharge apparatus.

The ink composition contains at least 2-pyrrolidone and an alcohol having a main chain having 6 or less carbon atoms. The 2-pyrrolidone in the ink composition can prevent drying of the ink that adheres to the nozzle surface. The alcohol having the main chain having 6 or less carbon atoms in the ink composition imparts improved drying property to the ink composition upon image formation.

The ink composition is not particularly limited as long as it contains, as organic solvents, at least 2-pyrrolidone and the alcohol having the main chain having 6 or less carbon atoms, and may be appropriately selected depending on the intended purpose. In addition to the organic solvents, the ink composition preferably contains, for example, a resin, water, and a coloring material, and if necessary, may further contain other components such as additives. As long as the ink composition contains at least 2-pyrrolidone and the alcohol having the main chain having 6 or less carbon atoms, the ink composition may be a clear ink without containing a coloring material.

### <<Resin>>

The resin in the ink composition is not particularly limited and may be appropriately selected depending on the intended purpose. Examples of the resin include, but are not limited to, a polyurethane resin, a polyester resin, an acrylic resin, a vinyl acetate resin, a styrene resin, a butadiene resin, a styrene-butadiene resin, a vinyl chloride resin, an acryl-styrene resin, and an acryl-silicone resin. These may be used alone or in combination.

As the resin, resin particles formed of any of the above resins are may be used. In a state of a resin emulsion in which the resin particles are dispersed using water as a dispersion medium, the resin particles can be mixed with materials such as the organic solvent and the coloring material to obtain the ink composition.

The resin particles for use may be appropriately synthesized resin particles or commercially available resin particles. One kind of the resin particles may be used or two or more kinds of the resin particles may be used in combination.

Of these, the resin contained in the ink composition is preferably a polyurethane resin.

The polyurethane resin is a reaction product between polyisocyanate and polyol. Examples of features of the polyurethane resin include, but are not limited to, respective performances exhibited by a soft segment made of a polyol component having a weak cohesive force and a hard segment made of a urethane bond having a strong cohesive force. The soft segment is soft and resistant to deformation of a base such as stretching and folding. The hard segment is high in adhesiveness to a base and is excellent in abrasion resistance.

The kind of the polyurethane resin is not particularly limited and may be appropriately selected depending on the intended purpose. Examples of the polyurethane resin include, but are not limited to, a polyether urethane resin, a polyester urethane resin, and polycarbonate urethane resin.

The proportion of the resin in the ink composition is preferably 6.0% by mass or more and more preferably 7.5% by mass or more. When the proportion of the resin in the ink composition is 6.0% by mass or more, the resin sufficiently adheres to a print medium, and high fixability is obtained also on permeating print media and low- or non-absorbing print media, and also the ink composition is excellent in storage stability.

The proportion of the resin in the ink composition is not particularly limited and may be appropriately selected depending on the intended purpose. The upper limit thereof is preferably 30% by mass or less and more preferably 20% by mass or less.

The upper limit and the lower limit of the proportion of the resin in the ink composition can be appropriately combined. The range of the proportion of the resin in the ink composition is preferably 6.0% by mass or more but 30% by mass or less and more preferably 7.5% by mass or more but 20% by mass or less.

The proportion of the resin relative to the total solid contents in the ink composition is not particularly limited and may be appropriately selected depending on the intended purpose. It is preferably 50% by mass or more and more preferably 70% by mass or more. When the proportion of the resin relative to the total solid contents in the ink composition is 50% by mass or more, the resin sufficiently adheres to a print medium, and high fixability is obtained also on permeating print media and low- or non-absorbing print media, and also the image formed is excellent in durability.

In the present specification, the solid contents in the ink composition include, for example, particles of the resin and the coloring material.

The volume average particle diameter of the resin particles in the ink composition is not particularly limited and may be appropriately selected depending on the intended purpose. In terms of achieving good fixability and high image hardness, the volume average particle diameter thereof is preferably 10 nm or more but 1,000 nm or less, more preferably 10 nm or more but 200 nm or less, and particularly preferably 10 nm or more but 100 nm or less.

The volume average particle diameter can be measured with, for example, a particle size distribution analyzer (NANOTRAC Wave-UT151, obtained from MicrotracBEL Corp.).

### <<Organic Solvent>>

The organic solvent in the ink composition contains at least 2-pyrrolidone and an alcohol having a main chain having 6 or less carbon atoms.

The 2-pyrrolidone in the ink composition can prevent drying of the ink composition in the vicinity of a nozzle, leading to excellent discharge stability.

The proportion of the 2-pyrrolidone in the ink composition is not particularly limited and may be appropriately selected depending on the intended purpose. It is preferably 0.5% by mass or more but 15.0% by mass or less and more preferably 1.0% by mass or more but 10.0% by mass or less.

The alcohol having the main chain having 6 or less carbon atoms in the ink composition achieves excellent drying property of an image.

The alcohol is not particularly limited as long as the main chain thereof has 6 or less carbon atoms, and may be appropriately selected depending on the intended purpose. Examples of the alcohol include, but are not limited to, divalent alcohols (glycols) and trivalent alcohols (triols). Of these, glycols are preferable because the ink composition is excellent in discharge stability of an ink and drying property of an ink upon image formation.

The glycols are not particularly limited and may be appropriately selected depending on the intended purpose. Examples of the glycols include, but are not limited to, ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropyleneglycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, and 2-ethyl-1,3-hexanediol.

The triols are not particularly limited and may be appropriately selected depending on the intended purpose. Examples of the triols include, but are not limited to, glycerin, 1,2,6-hexanetriol, ethyl-1,2,4-butanetriol, 1,2,3-butanetriol, and petriol.

The proportion of the alcohol having the main chain having 6 or less carbon atoms in the ink composition is not particularly limited and may be appropriately selected depending on the intended purpose. It is preferably 8.0% by mass or more but 50.0% by mass or less and 10.0% by mass or more but 40.0% by mass or less.

The organic solvent may include other organic solvents than the 2-pyrrolidone and the alcohol having the main chain having 6 or less carbon atoms.

The other organic solvents than the 2-pyrrolidone and the alcohol having the main chain having 6 or less carbon atoms are not particularly limited and may be appropriately selected depending on the intended purpose. Examples of the other organic solvents include, but are not limited to, polyvalent alcohol alkyl ethers, polyvalent alcohol aryl ethers, ethers, nitrogen-containing heterocyclic compounds, amides, amines, and sulfur-containing compounds.

The other organic solvents than the 2-pyrrolidone and the alcohol having the main chain having 6 or less carbon atoms may be similar to those described in the section —Cleaning liquid— of the <<Cleaning liquid applying unit and cleaning liquid applying step>>.

The proportion of the organic solvent in the ink composition is not particularly limited and may be appropriately selected depending on the intended purpose. In terms of drying properties and discharge reliability of the ink composition, it is preferably 10% by mass or more but 60% by mass or less and 20% by mass or more but 60% by mass or less.

### <<Water>>

The water in the ink composition is not particularly limited and may be appropriately selected depending on the intended purpose. For example, the water for use may be similar to those described in the section —Cleaning liquid— of the <<Cleaning liquid applying unit and cleaning liquid applying step>>.

The content of the water in the ink composition is not particularly limited and may be appropriately selected depending on the intended purpose. In terms of drying properties and discharge reliability of the ink composition, it is preferably 10% by mass or more but 90% by mass or less and 20% by mass or more but 60% by mass or less, relative to the total content of the ink composition.

### <<Coloring Material>>

The coloring material in the ink composition is not particularly limited and may be appropriately selected depending on the intended purpose. For example, pigments, pigment dispersions, and dyes can be used.

### —Pigment—

The pigment usable in the ink composition is an inorganic pigment or an organic pigment. These may be used alone or in combination. In addition, it is possible to use a mixed crystal as the pigment.

Examples of the pigment usable in the ink composition include, but are not limited to, black pigments, yellow pigments, magenta pigments, cyan pigments, white pigments, green pigments, orange pigments, gloss pigments of gold, silver, etc., and metallic pigments.

As the inorganic pigment, in addition to titanium oxide, iron oxide, calcium carbonate, barium sulfate, aluminum hydroxide, barium yellow, cadmium red, and chrome yellow, carbon black manufactured by known methods such as contact methods, furnace methods, and thermal methods can be used.

As the organic pigment, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black can be used.

Of these pigments in the ink composition, pigments having good affinity with the organic solvents and solvents such as water are preferable. Also, hollow resin particles and inorganic hollow particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rohdamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63; C.I. Pigment Green 1, 4, 7, 8, 10, 17, 18, and 36.

### —Pigment Dispersion—

The pigment dispersion can be obtained by mixing and dispersing a pigment with water, an organic solvent, a pigment, a pigment dispersant, and other optional components and adjusting the particle diameter.

A method for preparing the pigment dispersion by dispersing the pigment is not particularly limited and may be appropriately selected from known methods. Examples of the method include, but are not limited to: a method of mixing the pigment with materials such as water and organic solvents to produce the pigment dispersion; and a method of mixing materials such as water and organic solvents with a pigment dispersion, which is prepared by mixing the pigment with materials such as water and a pigment dispersant.

It is good to use a dispersing device for dispersion.

During the production, coarse particles are optionally filtered off with a filter, a centrifuge, etc. preferably followed by degassing.

The particle diameter of the pigment in the pigment dispersion has no particular limit. For example, the maximum frequency in the maximum number conversion is preferably 20 nm or more but 500 nm or less and more preferably from 20 nm or more but 150 nm or less to improve dispersion stability of the pigment and ameliorate the discharging stability and image quality such as image density.

The particle diameter of the pigment can be measured using a particle size distribution analyzer (NANOTRAC Wave-UT151, manufactured by MicrotracBEL Corp).

The content of the pigment in the pigment dispersion is not particularly limited and may be suitably selected to suit a particular application. In terms of improving discharging stability and image density, the content thereof is preferably from 0.1% by mass or more but 50% by mass or less and more preferably 0.1% by mass or more but 30% by mass or less.

### —Dye—

The type of dye in the ink composition is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The content of the coloring material in the ink composition is not particularly limited and may be suitably selected to suit a particular application. In terms of good fixability and discharge stability, it is preferably from 15% by mass or less and more preferably 10% by mass or less. The content of the coloring material being 0% by mass means that the ink composition can be used as a clear ink without containing the coloring material.

A method for dispersing the pigment to obtain the ink composition is not particularly limited and may be appropriately selected depending on the intended purpose. Examples of the method include, but are not limited to, a method of preparing a self-dispersible pigment by introducing a hydrophilic functional group into the pigment, a method of coating the surface of the pigment with a resin, and a method of dispersing the pigment using a dispersant.

As the method of preparing a self-dispersible pigment by introducing a hydrophilic functional group into a pigment, for example, it is possible to add a functional group such as a sulfone group and a carboxyl group to the pigment (e.g., carbon) to make the pigment dispersible in water.

As the method of coating the surface of the pigment with a resin, for example, the pigment is encapsulated by microcapsules to make the pigment dispersible in water. This can be referred to as a resin-coated pigment. In this case, the pigment to be added to the ink composition is not necessarily coated with the resin. Pigments partially or wholly uncovered with the resin may be dispersed in the ink composition unless the pigments have an adverse impact to the effects of the present disclosure.

As the method of dispersing the pigment using a dispersant, for example, a known dispersant of a small molecular weight type or a high molecular weight type represented by a surfactant is used to disperse the pigments.

The dispersant is not particularly limited. As the dispersant, it is possible to use, for example, anionic surfactants, cationic surfactants, amphoteric surfactants, nonionic surfactants, etc. depending on the pigments. These may be used alone or in combination.

The dispersant for use may be an appropriately synthesized dispersant or a commercially available dispersant. Examples of the commercially available dispersant include, but are not limited to, trade name NEWCALGEN D-1203 (obtained from TAKEMOTO OIL & FAT CO., LTD., a nonionic surfactant). Also, a formalin condensate of naphthalene sodium sulfonate can be suitably used as the dispersant.

### <<Other Components>>

The other components in the ink composition are not particularly limited as long as they do not impair the effects of the present disclosure, and may be appropriately selected depending on the intended purpose. Examples of the other components include, but are not limited to, a surfactant, a defoaming agent, preservatives and fungicides, a corrosion inhibitor, and a pH regulator.

The defoaming agent, the preservatives and fungicides, the corrosion inhibitor, the pH regulator, etc. in the ink composition are not particularly limited as long as they do not impair the effects of the present disclosure, and may be appropriately selected depending on the intended purpose. For example, they may be similar to those described in the section —Cleaning liquid— of the <<Cleaning liquid applying unit and cleaning liquid applying step>>.

### —Surfactant—

The surfactant in the ink composition is not particularly limited and may be appropriately selected depending on the intended purpose. Examples of the surfactant include, but are not limited to, silicone-based surfactants, fluoro surfactants, amphoteric surfactants, nonionic surfactants, and anionic surfactants. These may be used alone or in combination.

The silicone-based surfactant has no specific limit and can be suitably selected to suit to a particular application. Of these, preferred are silicone-based surfactants which are not decomposed even in a high pH environment.

Specific examples of the silicone-based surfactants, the amphoteric surfactants, the nonionic surfactants, and the anionic surfactants may be similar to those described in the section —Cleaning liquid— of the <<Cleaning liquid applying unit and cleaning liquid applying step>>.

The fluoro surfactant is not particularly limited and may be appropriately selected depending on the intended purpose. It is preferably a fluoro surfactant in which the number of carbon atoms substituted with fluorine atoms is from 2 through 16 and more preferably 4 through 16. Specific examples of the fluoro surfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because they do not foam easily and the fluoro surfactant represented by the following General Formula (F-1) or General Formula (F-2) is more preferable.

CF₃CF₂(CF₂CF₂)ₘ—CH₂CH₂O(CH₂CH₂O)ₙH General Formula (F-1)

In the General Formula (F-1), “m” is preferably an integer of from 0 through 10 and “n” is preferably an integer of from 0 to 40 in order to impart water solubility to the compound represented by General Formula (F-1).

CₙF₂ₙ₊₁CH₂CH(OH)CH₂—O—(CH₂CH₂O)ₐ—Y General Formula (F-2)

In the General Formula (F-2), “Y” represents H, CₘF₂ₘ₊₁, where “m” is an integer of from 1 to 6. CH₂CH(OH)CH₂—C_{q}F_{2q+1}, where “q” represents an integer of from 4 through 6, or CₚH₂ₚ₊₁, where p represents an integer of from 1 through 19. “n” represents an integer of from 1 through 6. “a” represents an integer of from 4 through 14.

The fluoro surfactant may be an appropriately synthesized fluoro surfactant or a commercially available fluoro surfactant. Specific examples of the commercially available fluoro surfactant include, but are not limited to: SURFLON (registered trademark) S-111, S-112, S-113, S-121, S-131, S-132, S-141, and S-145 (all manufactured by AGC SEIMI CHEMICAL CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL (registered trademark) TBS, FSP, FSA, FSN-100, FSN, FSO-100, FSO, FS-300, UR, CAPSTONE (registered trademark) FS-30, FS-31, FS-3100, FS-34, FS-35 (all manufactured by Du Pont); FT-110, FT-250, FT-251, FT-400S, FT-150, and FT-400SW (all manufactured by NEOS COMPANY LIMITED); POLYFOX PF-136A, PF-156A, PF-151N, PF-154, PF-159 (manufactured by OMNOVA SOLUTIONS INC.), and UNIDYNE DSN-403N (manufactured by DAIKIN INDUSTRIES). Of these, ZONYL (registered trademark) FS-3100, FS-34, and FS-300 (all manufactured by Du Pont), FT-110, FT-250, FT-251, FT-400S, FT-150, and FT-400SW (all manufactured by NEOS COMPANY LIMITED), PolyFox PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dying property to paper.

The content of the surfactant in the ink composition is not particularly limited and may be appropriately selected depending on the intended purpose. In terms of excellent wettability and discharging stability and improvement on image quality, it is preferably 0.001% by mass or more but 5% by mass or less and 0.05% by mass or more but 5% by mass or less, relative to the total content of the ink composition.

The particle diameter of the solids in the ink composition is not particularly limited and may be appropriately selected depending on the intended purpose. For example, the maximum frequency of the particle diameter of the solids in the ink composition in the maximum number conversion is preferably 20 nm or more but 500 nm or less and more preferably from 20 nm or more but 150 nm or less to improve dispersion stability and ameliorate the discharging stability and image quality such as image density.

The particle diameter of the solids in the ink composition can be measured using a particle size distribution analyzer (NANOTRAC Wave-UT151, manufactured by MicrotracBEL Corp).

The property of the ink composition is not particularly limited and may be appropriately selected depending on the intended purpose. For example, viscosity, surface tension, pH, etc., are preferably in the following ranges.

The viscosity of the ink composition at 25 degrees Celsius is preferably 5 mPa s or more but 30 mPa-s or less and more preferably 5 mPa-s or more but 25 mPa-s or less to improve print density and text quality and obtain good dischargeability.

The viscosity can be measured by, for example, a rotatory viscometer (RE-80L, manufactured by TOKI SANGYO CO., LTD.).

The measuring conditions are as follows:

Standard cone rotor (1° 34′×R24)
Sample liquid amount: 1.2 mL
Number of rotations: 50 rotations per minute (rpm)
25 degrees Celsius
Measuring time: three minutes

The surface tension of the ink composition is preferably 35 mN/m or less and more preferably 32 mN/m or less at 25 degrees Celsius in terms that the ink is suitably levelized on a print medium and the drying time of the ink is shortened.

The pH of the ink composition is preferably from 7 through 12 and more preferably from 8 through 11 in terms of prevention of corrosion of metal materials contacting the ink composition.

The applications of the ink composition of the present disclosure are not particularly limited and may be appropriately selected depending on the intended purpose. For example, the ink composition can be used for printed matter, a paint, a coating material, and foundation. The ink composition can be used to form two-dimensional texts and images and furthermore a three-dimensional solid object (3D modeling object) as a material for 3D modeling.

### <Print Medium>

The print medium used in the liquid discharge apparatus (the term “print medium” is used to have the same meaning as that of media or a print target) is not particularly limited. Specific examples thereof include, but are not limited to, plain paper, gloss paper, special paper, and cloth (e.g., cloth for apparel such as T-shirts). Non-permeating substrates can also be used. The liquid discharge apparatus includes the liquid discharge unit and the wiping unit, which is why good image formation is possible also in non-permeating substrates.

The print medium is not limited to articles used as typical print media. It is suitable to use building materials (e.g., wall paper, floor materials, and tiles), textile, and leather as the print medium. In addition, the configuration of the paths through which the print medium is transferred can be adjusted to use ceramics, glass, metal, etc.

The non-permeating substrate has a surface with low moisture permeability and absorbency and includes a material having myriad of hollow spaces inside but not open to the outside. To be more quantitative, the substrate has a water-absorption amount of 10 mL/m² or less between the contact and 30 msec^{1/2} after the contact according to Bristow method.

For example, plastic films of polyvinyl chloride resin, polyethylene terephthalate (PET), polypropylene, polyethylene, and polycarbonate are suitably used for the non-permeating substrate.

### (Ink Printed Matter)

With the liquid discharge apparatus of the present disclosure and the method of the present disclosure for wiping the liquid discharge unit, a print medium can be printed to form an ink printed matter. The ink printed matter including an image on the print medium, where the image is formed using the ink composition, is also within the scope of the present disclosure. The ink printed matter encompasses a three-dimensional solid object obtained by, for example, over-coating the ink. The ink printed matter also encompasses a molded processed product obtained by processing a structure including a base (e.g., a print medium) and an ink on the base.

Moreover, image forming, recording, printing, etc. in the present disclosure represent the same meaning.

The modeled processed product is fabricated by, for example, heating drawing or punching the ink printed matter having a sheet-like form, film-like form, etc. For example, it can be suitably used for the application of forming after decorating a surface, such as panels of meters or control units of cars, OA appliances, electric or electronic devices, cameras, etc.

Next, referring to some of the drawings, embodiments of the present disclosure will be described in detail. However, the present disclosure is not limited thereto.

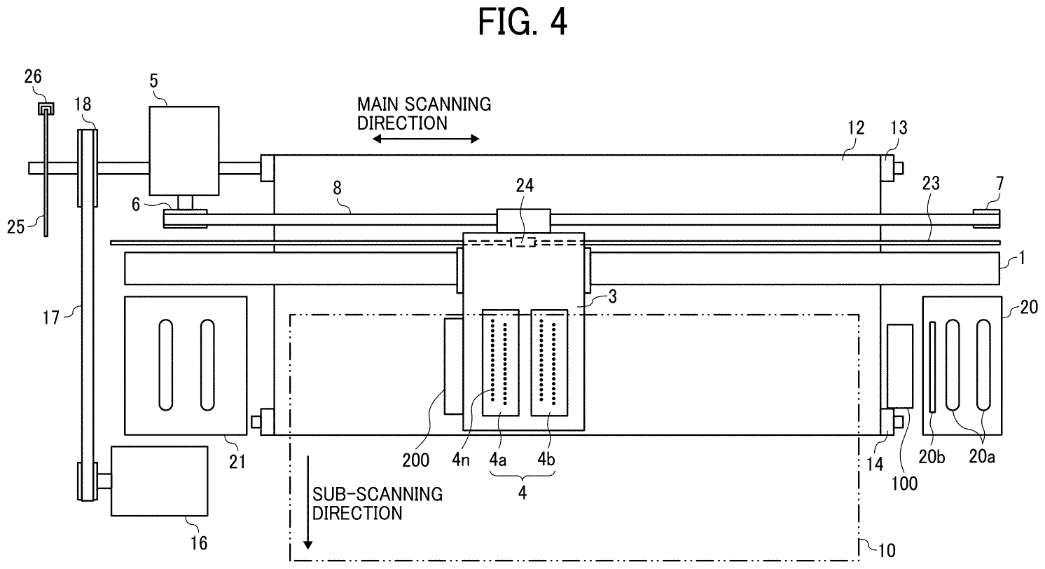

Referring to FIG. 4 to FIG. 6, an image forming apparatus (i.e., a printing apparatus that performs a printing method described below) will be described as one example of the liquid discharge apparatus of the present disclosure.

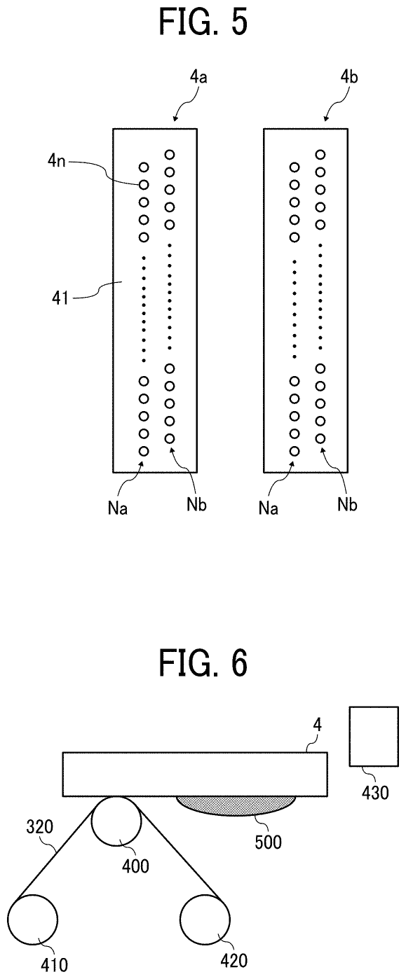

The image forming apparatus illustrated in FIG. 4 is a device configured to discharge an ink as one example of the ink composition. The image forming apparatus can be suitably applied to, for example, printers, facsimile machines, photocopiers, multifunction peripherals (serving as a printer, a facsimile machine, and a photocopier), and 3D model manufacturing devices. FIG. 4 is a diagram schematically illustrating the image forming apparatus as one example of the liquid discharge apparatus of the present disclosure. FIG. 5 is a diagram schematically illustrating one example of the nozzle surface of the liquid discharge unit in the liquid discharge apparatus of the present disclosure. FIG. 6 is a diagram schematically illustrating one example of the wiping system including the wiping unit in the liquid discharge apparatus of the present disclosure.

The image forming apparatus illustrated in FIG. 4 is a serial type image forming apparatus. The image forming apparatus movably holds a carriage 3 with a main guide member 1 and a sub guide member which are laterally bridged to left and right side plates. The carriage 3 is driven reciprocately in a main-scanning direction (a carriage travel direction) by a main scanning motor 5 via a timing belt 8 supported by a drive pulley 6 and an idler pulley 7. Print heads 4a and 4b (which will be referred to simply as a “print head 4” when they are not distinguished) each being an example of a liquid discharge head are mounted in the carriage 3. For example, the print head 4 discharges ink droplets of each color, e.g., yellow (Y), cyan (C), magenta (M), or black (K). Moreover, the print head 4 includes a nozzle array formed of a plurality of nozzles arranged in a sub-scanning direction orthogonal to the main-scanning direction, and the print head 4 is mounted in a manner that a droplet discharge direction faces downwards.

As illustrated in FIG. 5, the print head 4 includes a nozzle surface 41 provided with two nozzle arrays Na and Nb in each of which a plurality of nozzle arrays 4n are aligned. As the discharge head constituting the print head 4, for example, a piezoelectric actuator (e.g., a piezoelectric element) or a thermal actuator using a phase change due to film boiling of a liquid using a thermoelectric conversion element (e.g., a heat resistor) can be used. The print head 4 preferably has a water-repellant film on a surface thereof. The presence of the water-repellant film can prevent formation of adhesion matter of remaining ink or of ink in the vicinity of the nozzle, leading to improvement in dischargeability.

The image forming apparatus illustrated in FIG. 4 includes in order to convey a sheet 10 as one example of the print medium, a conveyor belt 12 which is a conveying unit configured to electrostatically attract a sheet to convey the sheet to a position facing the print head 4. The conveyor belt 12 is an endless belt, and is supported between a conveying roller 13 and a tension roller 14. The conveyor belt 12 is rotated in the sub-scanning direction by rotationally driving the conveying roller 13 by a sub-scanning motor 16 via a timing belt 17 and a timing pulley 18. The conveyor belt 12 is charged (given charges) by a charging roller while the conveyor belt 12 is rotating.

At one side of the main-scanning direction of the carriage 3, a maintenance recovery mechanism 20 configured to perform maintenance and recovery of the print head 4 is disposed at the side of the conveyor belt 12. At the other side of the main-scanning direction of the carriage 3, an idle discharge receiver 21 to which the print head 4 performs idle discharge is disposed at the side of the conveyor belt 12. For example, the maintenance recovery mechanism 20 includes a cap member 20a configured to cap a nozzle surface (a surface in which nozzles are formed) of the print head 4, a wiping mechanism 20b configured to wipe the nozzle surface, and the idle discharge receiver to which droplets not contributing to image formation are discharged. The wiping mechanism 20b configured to wipe the nozzle surface is one example of the wiping unit in the liquid discharge apparatus of the present disclosure.

Also, a discharge detection unit 100 is disposed in a region that is outside the printing region between the conveyor belt 12 and the maintenance recovery mechanism 20 and that is capable of facing the print head 4. The carriage 3 is provided with a cleaning unit 200 configured to clean the electrode plate of the discharge detection unit 100.

In the image forming apparatus, an encoder scale 23 having a predetermined pattern is stretched between the side plates of both sides along the main-scanning direction of the carriage 3. An encoder sensor 24 formed of a transmission photosensor configured to read the pattern of the encoder scale 23 is disposed in the carriage 3. The encoder scale 23 and the encoder sensor 24 constitute a linear encoder (a main scanning encoder) configured to detect the movement of the carriage 3.

A code wheel 25 is attached to the shaft of the conveying roller 13. An encoder sensor 26 formed of a transmission photosensor configured to detect the pattern formed in the code wheel 25 is also disposed. The code wheel 25 and the encoder sensor 26 constitute a rotary encoder (a sub-scanning encoder) configured to detect an amount of movement and moving position of the conveyor belt 12.

In the image forming apparatus constructed in the above-described manner, a sheet 10 is fed and attracted onto the charged conveyor belt 12. The sheet 10 is conveyed in the sub-scanning direction by the rotation of the conveyor belt 12. The print head 4 is driven in response to the image signal while the carriage 3 is being moved in the main-scanning direction, and ink droplets are discharged on the sheet 10 that is stopping to perform printing by one line. Then, the sheet 10 is conveyed by a predetermined distance, followed by performing printing for the next line. The printing operation is terminated by receiving a printing termination signal or a signal informing that the rear end of the sheet 10 reaches the printing region, and then the sheet 10 is discharged to the paper discharge tray.

When cleaning of the print head 4 is performed, the carriage 3 is moved to the maintenance recovery mechanism 20 during standing by for printing (recording), and then cleaning is performed by the maintenance recovery mechanism 20. The print head 4 may be cleaned by moving the maintenance recovery mechanism 20 with the print head 4 being not moved.

The recording head 4 illustrated in FIG. 4 includes two nozzle arrays Na and Nb in each of which a plurality of nozzle arrays 4n are aligned as illustrated in FIG. 5. One nozzle array Na of the print head 4a discharges droplets of black (K), and the other nozzle array Nb discharges droplets of cyan (C). One nozzle array Na of the print head 4b discharges droplets of magenta (M), and the other nozzle array Nb discharges droplets of yellow (Y).

FIG. 6 is a diagram schematically illustrating one example of a wiping system including a wiping unit according to the present disclosure.

The wiping system includes a cleaning liquid dropping device 430, which is the cleaning liquid applying unit, and a wiping unit. The wiping unit includes: a wiping member 320 in the form of a sheet, which is one example of the wiping member; a feeding roller 410 configured to feed the wiping member 320 in the form of a sheet; the cleaning liquid dropping device 430, which is one example of the cleaning liquid applying unit configured to perform the cleaning liquid applying step of applying the cleaning liquid to the fed wiping member 320 in the form of a sheet; a pressing roller 400, which is one example of the pressing unit configured to press against the nozzle surface the wiping member 320 in the form of a sheet to which the cleaning liquid has been applied; and a winding roller 420 configured to recover the wiping member 320 in the form of a sheet used for wiping. The cleaning liquid is supplied from a cleaning liquid accommodating container accommodating the cleaning liquid through a cleaning liquid supply tube provided, in the middle thereof, with a pump configured to supply the cleaning liquid. The wiping unit may include, for example, a rubber blade configured to wipe the nozzle surface, in addition to the wiping member 320 in the form of a sheet. The press roller 400 uses a spring, and a press force can be adjusted by adjusting a distance between a cleaning portion and the nozzle surface. The pressing unit is not limited to a roller, and may be a fixed member formed of a resin or rubber. In the case where the wiping unit includes, for example, the rubber blade, a cleaning function of the rubber blade may be imparted to the wiping member 320 in the form of a sheet by disposing a mechanism where the rubber blade is brought into contact with the wiping member 320 in the form of a sheet. In terms of downsizing, the wiping member 320 in the form of a sheet is preferably stored in the state of being wound into a roll, as illustrated in FIG. 6. This is not limitative, and the wiping member 320 may be stored in the state of being folded. The cleaning liquid applying unit may be a unit other than the cleaning liquid dropping device 430. Examples of the unit include, but are not limited to, a cleaning liquid applying roller configured to apply the cleaning liquid with a roller and a cleaning liquid applying spray configured to apply the cleaning liquid with a spray.

In the present embodiment, as one example of the wiping step, after applying a predetermined amount of a cleaning liquid to the wiping member 320 in the form of a sheet which is one example of the wiping unit, a maintenance recovery mechanism 20b and the print head 4 are relatively moved while the wiping member 320 is being against the nozzle surface 41 to perform a step of wiping foreign matter 500 deposited on the nozzle surface 41. Examples of the foreign matter 500 deposited on the nozzle surface 41 include, but are not limited to: a mist ink generated when the ink is discharged from the nozzle; the ink deposited when the ink is suctioned from the nozzle by, for example, cleaning; the adhesion ink generated when the mist ink or the ink deposited on the capping member are dried on the nozzle surface 41; and paper dust generated from the print target. In the present embodiment, applying the cleaning liquid to the wiping member 320 containing no cleaning liquid is followed by wiping the foreign matter 500. Alternatively, by using the wiping member 320 containing the cleaning liquid in advance, provision of the cleaning liquid applying unit may be avoided. The location to which the cleaning liquid is to be applied may be a location other than the wiping member 320, and the cleaning liquid may be directly applied to the nozzle surface 41. Tat is, the cleaning liquid applied to the nozzle surface 41 means all the cleaning liquid that is eventually applied to the nozzle surface 41. Examples thereof include, but are not limited to, the cleaning liquid directly applied to the nozzle surface 41 and the cleaning liquid indirectly applied to the nozzle surface 41 via the wiping member 320 containing the cleaning liquid. Preferable is the cleaning liquid indirectly applied to the nozzle surface 41 via the wiping member 320 containing the cleaning liquid. When it is expected that the ink would be dried and adhere on the nozzle surface 41, for example, after a long-term stand by, it is preferable to wipe the nozzle surface 41 twice or more with the wiping member 320 containing the cleaning liquid, to remove the foreign matter. The wiping step may be a step of wiping the nozzle surface without using the cleaning liquid.

### EXAMPLES

The present disclosure will be described below by way of Examples and Comparative Examples. The present disclosure should not be construed as being limited to these Examples.

### Preparation Example 1

### <Preparation of White Pigment Dispersion>

Titanium oxide (STR-100W, obtained from SAKAI CHEMICAL INDUSTRY CO., LTD.) (25 g), a pigment dispersant (TEGO Dispers651, obtained from Evonik Industries) (5 g), and water (70 g) were mixed together. The titanium oxide was dispersed for 5 minutes in a bead mill (research lab type, obtained from Shinmaru Enterprises Corporation) under conditions of 60% of a filling rate of zirconia beads 0.3 mm in diameter and 8 m/sec, to obtain a white pigment dispersion having a volume average particle diameter of 285 nm.

The volume average particle diameter of the white pigment dispersion was measured with a particle size distribution analyzer (NANOTRAC Wave-UT151, obtained from MicrotracBEL Corp.).

### <Preparation of Urethane Resin Emulsion>

A reaction container into which a stirrer, a reflux condenser, and a thermometer were inserted was charged with polyester polyol (POLYLITE OD-X-2420, obtained from DIC Corporation) (1,500 g), 2,2-dimethylolpropionic acid (DMPA) (220 g), and N-methylpyrrolidone (NMP) (1,347 g) in a nitrogen atmosphere, followed by heating to 60 degrees Celsius to dissolve DMPA. Next, 4,4′-dicyclohexylmethane diisocyanate (1,445 g) and dibutyltin dilaurate (catalyst) (2.6 g) were added to the mixture. The resultant mixture was then heated to 90 degrees Celsius to perform urethanization reaction over 5 hours, to obtain an isocyanate-ended urethane prepolymer. This reaction mixture was cooled to 80 degrees Celsius, followed by addition of triethylamine (149 g) and mixing. Part (4,340 g) of the mixture was taken out, and added under vigorous stirring to a mixed solution of water (5,400 g) and triethylamine (15 g). Next, ice (1,500 g) was charged to the mixture, followed by addition of a 35% by mass 2-methyl-1,5-pentanediamine aqueous solution (626 g) to perform chain extending reaction. The solvent was distilled off so that the concentration of the solids would be 30% by mass. The obtained resin emulsion was subjected to a dispersion treatment with a paint conditioner (obtained from RED DEVIL, the speed is adjustable in the range of from 5 rpm through 1,425 rpm) to obtain a urethane resin emulsion having a solid concentration of 40.0% by mass.

### <Preparation of Ink Composition>

In accordance with the materials and amounts thereof (% by mass) presented in Table 1 below, the white pigment dispersion (7.0% by mass (as the concentration of solids)), 2-pyrrolidone (5.0% n mass), 1,2-butanediol (20.0% by mass), diethylene glycol monobutyl ether (5.0% by mass), a fluoro surfactant (DuPont ZONYL (registered trademark) FS-300, obtained from Du Pont) (2.0% by mass), a preservative (PROXEL LV(S), obtained from Lonza Japan) (0.1% by mass), and ion-exchanged water (52.9% by mass (balance)) were mixed and stirred, followed by filtration through a 0.5 micrometers polypropylene filter, to prepare an ink composition of Preparation Example 1.

### Preparation Examples 2 to 11

Ink compositions of Preparation Examples 2 to 11 were prepared in the same manner as in Preparation Example 1 except that unlike in Preparation Example 1, the amounts of the white pigment dispersion and the urethane resin emulsion were changed to those presented in Table 1 and Table 2 below.

TABLE 1

| | Ink compositions | | | | | |
|---|---|---|---|---|---|---|
| Names of | Prep. | Prep. | Prep. | Prep. | Prep. | Prep. |
| components | Ex. 1 | Ex. 2 | Ex. 3 | Ex. 4 | Ex. 5 | Ex. 6 |
| White pigment | 7.0 | 7.0 | 7.0 | 7.0 | 7.0 | 7.0 |
| dispersion | | | | | | |
| (concentration | | | | | | |
| of solids) | | | | | | |
| Urethane resin | 8.0 | 8.0 | — | 6.5 | 8.0 | 8.0 |
| emulsion | | | | | | |
| (concentration | | | | | | |
| of solids) | | | | | | |
| Acrylic resin | — | — | 8.0 | — | — | — |
| emulsion | | | | | | |
| (concentration | | | | | | |
| of solids) | | | | | | |
| 2-Pyrrolidone | 5.0 | 5.0 | 5.0 | 5.0 | 5.0 | 0.8 |
| 1,2-Butanediol | 20.0 | — | 20.0 | 20.0 | — | 20.0 |
| 1,2-Hexanediol | — | 20.0 | — | — | — | — |
| Glycerin | — | — | — | — | 20.0 | — |
| Diethylene | 5.0 | 5.0 | 5.0 | 5.0 | 5.0 | 5.0 |
| glycol | | | | | | |
| monobutyl | | | | | | |
| ether | | | | | | |
| DuPont | 2.0 | 2.0 | 2.0 | 2.0 | 2.0 | 2.0 |
| ZONYL | | | | | | |
| (registered | | | | | | |
| trademark) | | | | | | |
| FS-300 | | | | | | |
| PROXEL | 0.1 | 0.1 | 0.1 | 0.1 | 0.1 | 0.1 |
| LV(S) | | | | | | |
| Ion-exchanged | Balance | Balance | Balance | Balance | Balance | Balance |
| water | | | | | | |
| Total of | 53.3 | 53.3 | 53.3 | 48.1 | 53.3 | 53.3 |
| resin/solids | | | | | | |
| (% by mass) | | | | | | |

TABLE 2

| | Ink compositions | | | | |
|---|---|---|---|---|---|
| | Prep. | Prep. | Prep. | Prep. | Prep. |
| Names of components | Ex. 7 | Ex. 8 | Ex. 9 | Ex. 10 | Ex 11 |
| White pigment dispersion | 7.0 | 7.0 | 7.0 | 7.0 | 7.0 |
| (concentration of solids) | | | | | |
| Urethane resin emulsion | 8.0 | 8.0 | 8.0 | 8.0 | 8.0 |
| (concentration of solids) | | | | | |
| Acrylic resin emulsion | | | | | |
| (concentration of solids) | | | | | |
| 2-Pyrrolidone | 11.0 | 5.0 | 5.0 | — | 5.0 |
| 1,2-Butanediol | 20.0 | 9.0 | 41.0 | 20.0 | — |
| 1,2-Hexanediol | — | — | — | — | — |
| Glycerin | — | — | — | — | — |
| Diethylene glycol | 5.0 | 5.0 | 5 0 | 5.0 | 20.0 |
| monobutyl ether | | | | | |
| DuPont ZONYL | 2.0 | 2.0 | 2.0 | 2.0 | 2.0 |
| (registered trademark) | | | | | |
| FS-300 | | | | | |
| PROXEL LV(S) | 0.1 | 0.1 | 0.1 | 0.1 | 0.1 |
| Ion-exchanged water | Balance | Balance | Balance | Balance | Balance |

### Examples 1 to 14 and Comparative Examples 1 to 4

### —Provision of Wiping Member—

Non-woven fabric in the form of a sheet made of the material presented in Table 3 below was used as a wiping member. Next, this wiping member was mounted to a wiping unit illustrated in FIG. 6. OCTA (registered trademark) (obtained from TEIJIN FRONTIER CO., LTD.) used in Examples 3, 4, and 6 to 14, and Comparative Examples 3 and 4 is a fiber. Thus, this was processed into non-woven fabric, which was used as a wiping member.

Using a scanning electron microscope (SEM: obtained from KEYENCE CORPORATION, VE7800), each fiber was confirmed for the shape of a cross-section orthogonal to a fiber axis thereof, the number of protruded portions in the cross-section orthogonal to the fiber axis thereof, and the number of regions (A) formed by part of the periphery of the cross-section and part of the circumscribed circle of the cross-section. Also, from the SEM image of the fiber, the area of the cross-section orthogonal to the fiber axis thereof and the area of the circumscribed circle of the cross-section were determined to calculate a fiber porosity from Formula (2) below. Results are presented in Table 3 below.

Fiber Porosity=(1−A/B)×100 Formula (2)

In the Formula (2). “A” denotes an area of the cross-section of the fiber orthogonal to the fiber axis thereof, and “B” denotes an area of the circumscribed circle of the cross-section of the fiber orthogonal to the fiber axis thereof. When the fiber has a hollow portion, the area of the hollow portion is not included in the above cross-sectional area “A”.

Next, the shapes of the fibers used as the wiping members in Examples 1 to 14 and Comparative Examples 1 to 4 will be described. FIG. 3 is a diagram schematically illustrating the cross-sections of the fibers used as the wiping members in Examples 1 to 14 and Comparative Examples 1 to 4, the cross-sections being orthogonal to the fiber axes thereof, and the circumscribed circles of the cross-sections. The cross-sections are indicated in black and the circumscribed circles are indicated by a gray dotted line. The (a) of FIG. 3 represents a fiber constituting DILLA (registered trademark) D0903WPO (obtained from UNITIKA LTD.), the (b) of FIG. 3 represents a fiber constituting OCTA (registered trademark) (obtained from TEIJIN FRONTIER CO., LTD.), and the (c) of FIG. 3 represents a fiber constituting BEMLIESE (registered trademark) SE103 (obtained from Asahi Kasei Corporation).

In accordance with the combinations presented in Table 3 below, liquid discharge apparatuses of Examples 1 to 14 and Comparative Examples 1 to 4 were produced, each of the liquid discharge apparatuses including each of the ink compositions obtained in Preparation Examples 1 to 11, an inkjet head (RICHO MH5440, obtained from Ricoh Company, Limited) as the liquid discharge unit, and a wiping unit including the wiping member.

The liquid discharge apparatuses were evaluated for “wiping performance”, “head damage”, “discharge stability”, and “drying property” in the following manners. Results are presented in Table 3 below.

### [Evaluation]

### <Evaluation of Wiping Performance>

As an inkjet head, RICOH MH5440 (obtained from Ricoh Company, Limited) was used. Each (0.1 ml) of the ink compositions prepared in Preparation Examples 1 to 11 as presented in Table 3 below was dropped on the nozzle plate of the head, followed by being left to stand for 15 hours, to form a nozzle plate to which the ink adhered.

A cleaning liquid (product name: RICOH Flushing Cartridge Type C2, obtained from Ricoh Company, Limited) was applied at 20 microliters/cm² to each of the wiping members presented in Table 3 below. In a laboratory environment (23 degrees Celsius, 60% RH), the nozzle plate surface was wiped at a wiping linear pressure presented in Table 3 below and at a wiping speed of 50 mm/sec.

The nozzle plate after wiping was visually observed to determine the number of wiping operations necessary for the adhesion ink to be removed, and “wiping performance” was evaluated based on the following evaluation criteria. Results are presented in Table 4 below.

In the following evaluation criteria, A, B, or C are practically acceptable levels, with B being preferable, A being further preferable.

### —Evaluation Criteria of “Wiping Performance”—

A: The adhesion ink on the nozzle plate was removed by five wiping operations.

B: The adhesion ink on the nozzle plate was removed by seven wiping operations.

C: The adhesion ink on the nozzle plate was removed by nine wiping operations.

D: The adhesion ink remained at the time of 10 wiping operations.

### <Evaluation of Head Damage>

Using RICOH Pro L5160 modified by incorporating each of the liquid discharge apparatuses of Examples 1 to 14 and Comparative Examples 1 to 4, a head cleaning operation of “weak” was performed 10,000 times according to the conditions of Table 3 below. After the operation, the state of discharge was confirmed to evaluate “head damage” based on the following evaluation criteria. Results are presented in Table 4 below.

In the following evaluation criteria, A, B, or C are practically acceptable levels, with B being preferable, A being further preferable.

### —Evaluation Criteria of “Head Damage”—

A: Neither turbulent discharge nor non-discharge was observed.

B: Turbulent discharge or non-discharge was observed in two or less nozzles.

C: Turbulent discharge or non-discharge was observed in three or more but five or less nozzles.

D: Turbulent discharge or non-discharge was observed in more than five nozzles.

### <Evaluation of Discharge Stability>

As presented in Table 3 below, intermittent printing was performed by RICOH Pro L5160 charged with each of the ink compositions prepared in Preparation Examples 1 to 11. One cycle of the intermittent printing was continuously printing a print chart of 100% duty on five PVC film print media, followed by suspending discharging for 10 minutes. This cycle was repeated 10 times to print a total of 50 print media. Thereafter, the 51^{th} print medium printed with the same chart was confirmed for a 5% chart solid portion. Based on the following evaluation criteria, “discharge stability” was evaluated. Results are presented in Table 4 below. In the following evaluation criteria, A or B is a practically acceptable level, with B being preferable, A being further preferable.

### —Evaluation Criteria of “Discharge Stability”—

A: Almost no streak, spot, or trace of turbulent jetting were observed in the solid portion.

B: Streak, spot, and trace of turbulent jetting were slightly observed in the solid portion.

C: Streak, spot, and trace of turbulent jetting were observed over the entirety of the solid portion.

### <Drying Property>

As presented in Table 3 below, a solid image was formed on PVC film print media by RICOH Pro L5160 charged with each of the ink compositions prepared in Preparation Examples 1 to 11. The obtained solid image was dried on a hot plate (device name: NINOS ND-1, obtained from AS ONE Corporation) set to 60 degrees Celsius. A black filter paper sheet was pressed against the dried solid image, and transfer of the ink onto the filter paper sheet was visually observed. Based on the following evaluation criteria, “drying property” was evaluated. Results are presented in Table 4 below. In the following evaluation criteria, A or B is a practically acceptable level, with B being preferable, A being further preferable.

### —Evaluation Criteria of “Drying Property”—

A: Under drying conditions of 60 degrees Celsius and five minutes or shorter, no transfer onto the filter paper sheet was observed.

B: Under drying conditions of 60 degrees Celsius and longer than five minutes but eight minutes or shorter, no transfer onto the filter paper sheet was observed.

C: Under drying conditions of 60 degrees Celsius and longer than eight minutes, transfer onto the filter paper sheet was still observed.

TABLE 3

| | Wiping member | | | | | |
|---|---|---|---|---|---|---|
| | Number of | | | | | |
| | protruded | | | | Wiping | |
| | portions in the | Fiber | Number of | | linear | |
| | fiber cross- | porosity | regions | | pressure | Ink |
| | section | [%] | (A) | Product names | [N/cm] | composition |
| Example 1 | 4 | 42 | 8 | DILA (registered trademark) | 1.7 | Preparation |
| | | | | D0903WPO | | Example 1 |
| Example 2 | 4 | 42 | 8 | DILLA (registered trademark) | 0.6 | Preparation |
| | | | | D0903WPO | | Example 1 |
| Example 3 | 8 | 55 | 4 | OCTA (registered trademark) | 1.7 | Preparation |
| | | | | | | Example 1 |
| Example 4 | 8 | 55 | 4 | OCTA (registered trademark) | 0.6 | Preparation |
| | | | | | | Example 1 |
| Example 5 | 4 | 42 | 8 | DILA (registered trademark) | 2.0 | Preparation |
| | | | | D0903WPO | | Example 1 |
| Example 6 | 8 | 55 | 4 | OCTA (registered trademark) | 2.0 | Preparation |
| | | | | | | Example 1 |
| Example 7 | 8 | 55 | 4 | OCTA (registered trademark) | 0.6 | Preparation |
| | | | | | | Example 2 |
| Example 8 | 8 | 55 | 4 | OCTA (registered trademark) | 0.6 | Preparation |
| | | | | | | Example 3 |
| Example 9 | 8 | 55 | 4 | OCTA (registered trademark) | 0.6 | Preparation |
| | | | | | | Example 4 |
| Example 10 | 8 | 55 | 4 | OCTA (registered trademark) | 0.6 | Preparation |
| | | | | | | Example 5 |
| Example 11 | 8 | 55 | 4 | OCTA (registered trademark) | 0.6 | Preparation |
| | | | | | | Example 6 |
| Example 12 | 8 | 55 | 4 | OCTA (registered trademark) | 0.6 | Preparation |
| | | | | | | Example 7 |
| Example 13 | 8 | 55 | 4 | OCTA (registered trademark) | 0.6 | Preparation |
| | | | | | | Example 8 |
| Example 14 | 8 | 55 | 4 | OCTA (registered trademark) | 0.6 | Preparation |
| | | | | | | Example 9 |
| Comparative | 0 | 0 | 0 | BEMLIESE (registered trademark) | 1.7 | Preparation |
| Example 1 | | | | SE103 | | Example 1 |
| Comparative | 0 | 0 | 0 | BEMLIESE (registered trademark) | 0.5 | Preparation |
| Example 2 | | | | SE103 | | Example 1 |
| Comparative | 8 | 55 | 4 | OCTA (registered trademark) | 0.6 | Preparation |
| Example 3 | | | | | | Example 10 |
| Comparative | 8 | 55 | 4 | OCTA (registered trademark) | 0.6 | Preparation |
| Example 4 | | | | | | Example 11 |

TABLE 4

| | Evaluation results | | | |
|---|---|---|---|---|
| | Wiping | Head | Discharge | Drying |
| | performance | damage | stability | property |
| Example 1 | A | B | A | A |
| Example 2 | B | A | A | A |
| Example 3 | A | B | A | A |
| Example 4 | A | A | A | A |
| Example 5 | A | C | A | A |
| Example 6 | A | c | A | A |
| Example 7 | A | A | A | A |
| Example 8 | A | A | A | A |
| Example 9 | A | A | A | A |
| Example 10 | A | A | B | B |
| Example 11 | A | A | B | A |
| Example 12 | A | A | A | B |
| Example 13 | A | A | A | B |
| Example 14 | A | A | B | A |
| Comparative | D | B | A | A |
| Example 1 | | | | |
| Comparative | D | A | A | A |
| Example 2 | | | | |
| Comparative | A | A | C | A |
| Example 3 | | | | |
| Comparative | A | A | A | C |
| Example 4 | | | | |

Aspects and embodiments of the present disclosure are as follows, for example.

<1> A liquid discharge apparatus, including:

an ink composition containing 2-pyrrolidone and an alcohol having a main chain having 6 or less carbon atoms;

a liquid discharge unit configured to discharge an ink composition from a nozzle formed in a nozzle surface; and

a wiping unit configured to wipe the nozzle surface.

the wiping unit including a wiping member including protrusion-shape fibers,

wherein each of the protrusion-shape fibers has a protruded portion in a cross-section orthogonal to a fiber axis thereof, and

the protruded portion is continuous in a direction along the fiber axis.

<2> The liquid discharge apparatus according to <1> above, further including a pressing unit configured to press the wiping member against the nozzle surface.

<3> The liquid discharge apparatus according to <1> or <2> above, wherein the wiping member wipes the nozzle surface at a linear pressure of 1.7 N/cm or less at a contact portion between the wiping member and the nozzle surface.

<4> The liquid discharge apparatus according to <1> or <2> above, wherein the wiping member wipes the nozzle surface at a linear pressure of 0.6 N/cm or less at a contact portion between the wiping member and the nozzle surface.

<5> The liquid discharge apparatus according to any one of <1> to <4> above, wherein each of the protrusion-shape fibers has three or more protruded portions in the cross-section.

<6> The liquid discharge apparatus according to any one of <1> to <5> above, wherein each of the protrusion-shape fibers has three or more regions formed by part of a periphery of the cross-section and part of a circumscribed circle of the cross-section.

<7> The liquid discharge apparatus according to any one of <1> to <6> above, wherein the protrusion-shape fibers have a fiber porosity of 20% or more but 80% or less.

<8> The liquid discharge apparatus according to any one of <1> to <7> above, wherein the nozzle surface includes a water-repellant film.

<9> The liquid discharge apparatus according to any one of <1> to <8> above, wherein the ink composition further contains a resin, and a proportion of the resin to total solid contents in the ink composition is 50% by mass or more.

<10> The liquid discharge apparatus according to any one of <1> to <9> above, wherein a proportion of the 2-pyrrolidone in the ink composition is 1.0% by mass or more but 10.0% by mass or less.

<11> The liquid discharge apparatus according to any one of <1> to <10> above, wherein a proportion of the alcohol having the main chain having 6 or less carbon atoms in the ink composition is 10.0% by mass or more but 40.0% by mass or less.

<12> The liquid discharge apparatus according to any one of <1> to <11> above, wherein the resin comprises a polyurethane resin.

<13> The liquid discharge apparatus according to any one of <1> to <12> above, wherein the alcohol comprises a glycol.

<14> A method for wiping a liquid discharge unit, the method including:

wiping, with a wiping unit, a nozzle surface in the liquid discharge unit configured to discharge an ink composition from a nozzle formed in the nozzle surface,

wherein the ink composition contains at least 2-pyrrolidone and an alcohol having a main chain having 6 or less carbon atoms,

the wiping unit includes a wiping member including protrusion-shape fibers,

each of the protrusion-shape fibers has a protruded portion in a cross-section orthogonal to a fiber axis thereof, and

the protruded portion is continuous in a direction along the fiber axis.

<15> The method according to <14> above, further including pressing the wiping member against the nozzle surface.

<16> The method according to <14> or <15> above, wherein a linear pressure at a contact portion between the wiping member and the nozzle surface when the wiping member wipes the nozzle surface is 1.7 N/cm or less.

<17> The method according to any one of <14> to <16> above, wherein a linear pressure at a contact portion between the wiping member and the nozzle surface when the wiping member wipes the nozzle surface is 0.6 N/cm or less.

<18> The method according to any one of <14> to <17> above, wherein each of the protrusion-shape fibers has three or more protruded portions in the cross-section.

<19> The method according to any one of <14> to <18> above, wherein each of the protrusion-shape fibers has three or more regions formed by part of a periphery of the cross-section and part of a circumscribed circle of the cross-section.

<20> The method according to any one of <14> to <19> above, wherein the protrusion-shape fibers have a fiber porosity of 20% or more but 80% or less.

<21> The method according to any one of <14> to <20> above, wherein the nozzle surface includes a water-repellant film.

<22> The method according to any one of <14> to <21> above, wherein a proportion of the resin to total solid contents in the ink composition is 50% by mass or more.

<23> The method according to any one of <14> to <22> above, wherein a proportion of the 2-pyrrolidone in the ink composition is 1.0% by mass or more but 10.0% by mass or less.

<24> The method according to any one of <14> to <23> above, wherein a proportion of the alcohol having the main chain having 6 or less carbon atoms in the ink composition is 10.0% by mass or more but 40.0% by mass or less.

<25> The method according to any one of <14> to <24> above, wherein the resin comprises a polyurethane resin.

<26> The method according to any one of <14> to <25> above, wherein the alcohol comprises a glycol.

The liquid discharge apparatus according to any one of <1> to <13> above and the method according to any one of <14> to <26> above can solve existing problems in the art and can achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge apparatus, comprising:
an ink composition containing 2-pyrrolidone and an alcohol having a main chain having 6 or less carbon atoms;
a liquid discharge unit configured to discharge the ink composition from a nozzle formed in a nozzle surface; and
a wiping unit configured to wipe the nozzle surface,
the wiping unit including a wiping member including protrusion-shape fibers,
wherein each of the protrusion-shape fibers has a protruded portion in a cross-section orthogonal to a fiber axis thereof, and
the protruded portion is continuous in a direction along the fiber axis.

2. The liquid discharge apparatus according to claim 1, further comprising a pressing unit configured to press the wiping member against the nozzle surface.

3. The liquid discharge apparatus according to claim 1, wherein the wiping member wipes the nozzle surface at a linear pressure of 1.7 N/cm or less at a contact portion between the wiping member and the nozzle surface.

4. The liquid discharge apparatus according to claim 1, wherein each of the protrusion-shape fibers has three or more protruded portions in the cross-section.

5. The liquid discharge apparatus according to claim 1, wherein each of the protrusion-shape fibers has three or more regions each formed by part of a periphery of the cross-section and part of a circumscribed circle of the cross-section.

6. The liquid discharge apparatus according to claim 1, wherein the protrusion-shape fibers have a fiber porosity of 20% or more but 80% or less.

7. The liquid discharge apparatus according to claim 1, wherein the nozzle surface includes a water-repellant film.

8. The liquid discharge apparatus according to claim 1, wherein the ink composition further contains a resin, and a proportion of the resin to total solid contents in the ink composition is 50% by mass or more.

9. The liquid discharge apparatus according to claim 1, wherein the alcohol comprises a glycol.

10. A method for wiping a liquid discharge unit, the method comprising:
wiping, with a wiping unit, a nozzle surface in the liquid discharge unit configured to discharge an ink composition from a nozzle formed in the nozzle surface,
wherein the ink composition contains 2-pyrrolidone and an alcohol having a main chain having 6 or less carbon atoms,
the wiping unit includes a wiping member including protrusion-shape fibers,
each of the protrusion-shape fibers has a protruded portion in a cross-section orthogonal to a fiber axis thereof, and
the protruded portion is continuous in a direction along the fiber axis.
